(19) United States
(12) Patent Application Publication
(10) Pub. No.: US 2024/0288102 A1
(43) Pub. Date: Aug. 29, 2024

(54) PIPE

(71) Applicant: FUJIKIN INCORPORATED, Osaka-shi (JP)

(72) Inventors: Toshinori Ochiai, Osaka-shi (JP); Takayasu Nakahama, Osaka-shi (JP); Katsutoshi Shoji, Osaka-shi (JP)

(73) Assignee: FUJIKIN INCORPORATED, Osaka-shi (JP)

(21) Appl. No.: 18/581,560

(22) Filed: Feb. 20, 2024

(30) Foreign Application Priority Data
Feb. 24, 2023 (JP) 2023-026829

(51) Int. Cl. F16L 19/02; F16L 19/025

(52) U.S. Cl. CPC F16L 19/0237; F16L 19/0218; F16L 19/025

(57) ABSTRACT

To provide a pipe in which the pipe having been fixed is prevented from being loosened by co-rotation. A pipe includes at least a first pipe and a second pipe and connects blocks each having an internal flow path and an open end of the flow path on a surface thereof. The other end portion of the first pipe is provided with an outward flange, and an annular gasket is interposed between butt end faces of the first and second pipes, and a male thread member that is inserted onto the first pipe, has male threads on a peripheral surface thereof, and abuts against the outward flange. The other end portion of the second pipe is provided with a cap nut member that is inserted onto the second pipe, has an outward flange, has female threads, and has an inward flange to be engaged with the outward flange.

### BACKGROUND OF THE INVENTION

### Field of the Invention

The present invention relates to a pipe that connects blocks to each other and, more particularly, to a pipe that has a joint function and connects blocks to each other.

### Description of the Related Art

A pipe that connects substantially cubic blocks each having an internal flow path and at least two open ends of the internal flow path on the surface of each of the blocks is widely used in various fields.

For example, in blocks 4 and a pipe 100 illustrated in FIGS. 7A and 7B, a tapered seal portion 40 and a female thread portion 43 are formed in open ends portion of an internal flow path 41, and a tapered surface 10 is pressed against and fixed to an end of the pipe to prevent a fluid flowing through the blocks 4 and the pipe 100 from leaking to the outside.

Such a structure is generally referred to as a cone thread joint, and the tapered surface 10 and a male thread portion 11 are formed at the end of the pipe 100. In addition, a fixing member 14 that has a through-hole 14c with a diameter slightly larger than the diameter of the pipe and has, on the peripheral surface, an engagement portion 14b that engages a male thread portion 14a and a tool and a stopper 15 to be screwed with the male thread portion 11 of the pipe 100 are attached to the end of the pipe 100, as illustrated in the drawing, the tapered surface 10 at the end of the pipe is pressed against the tapered seal portion 40 of the block 4, the male thread portion 14a of the fixing member 14 is screwed with the female thread portion 43 formed on the inner peripheral surface of an installation space 42 closer to the open end than the tapered seal portion 40 of the block 4, and the male thread portion 14a is screwed until an end of the fixing member 14 abuts against the stopper 15, and accordingly, the tapered surface 10 abuts against the tapered seal portion 40 to achieve sealing.

Such connection including the blocks and the pipe is used in, for example, the hydrogen station unit described in JP2019-203573A. In the unit described in JP2019-203573A, a space for pulling out the pipe is provided.

### CITATION LIST

### Patent Literature

PLL1: JA2019-203573A

### SUMMARY OF THE INVENTION

### Technical Problem

However, when a cone thread joint is used for joint between the blocks and the pipe, if the pipe is fixed to one block and then a nut as a fixing member for the other block is tightened, co-rotation of the pipe occurs, disadvantageously loosening the pipe for the block on the fixed side, as illustrated in FIGS. 7A and 7B. In addition, when the pipe is removed from the block for maintenance or the like after construction, there is a problem in that the block to which the pipe has been attached needs to be moved by a pipe drawing margin H illustrated in the drawing. Furthermore, when both of the blocks to which the pipe has been fixed are restrained after construction, there is a problem in that maintenance takes a lot of time because one of the restrained blocks needs to be released or the pipe needs to be cut, etc.

The present invention addresses the problems described above with an object of providing a pipe in which the fixed pipe is prevented from being loosed by co-rotation when the pipe is attached to blocks and that has good maintainability.

### Solution to Problem

To solve the problems described above, according to the present invention, there is provided a pipe that connects blocks each having an internal flow path and an open end of the flow path on a surface thereof, the pipe including: at least a first pipe and a second pipe, in which one end portion of each of the first and second pipes is provided with a tapered surface that comes into contact with a tapered seal portion formed at an open end of each of the blocks and a male thread portion closer to another end portion of each of the first and second pipes than the tapered surface, the other end portion is provided with an outward flange, and an annular gasket is interposed between butt end faces of the first and second pipes, and the other end portion of the first pipe is provided with a male thread member that is inserted onto the first pipe, has male threads on a peripheral surface thereof, and abuts against the outward flange, and the other end portion of the second pipe is provided with a cap nut member that is inserted onto the second pipe, has female threads on an inner surface thereof to be screwed with the male threads, and has an inward flange to be engaged with the outward flange.

The pipe according to the present invention couples both blocks facing each other by fixing one ends of the first and second pipes in which tapered surfaces have been formed to the blocks and coupling, to each other, the male thread member and the cap nut member provided at the other ends of the first and second pipes. At this time, since the first and second pipes are connected to each other via the male thread member and the cap nut member on the other end side, loosening due to co-rotation does not occur.

In this case, a third pipe is provided between the first and second pipes connected to the blocks, and outward flanges are formed at both ends of the third pipe, and the male thread member and the cap nut member can be inserted onto the outward flanges.

In addition, in this case, at least one of the outward flanges can be retrofitted to an end portion of the third pipe.

### Advantageous Effects of Invention

In the pipe according to the present invention, loosening due to co-rotation does not occur during construction of the pipe. In addition, during maintenance as well, the pipe can be removed only by moving the pipe by approximately a distance equivalent to the diameter in a direction orthogonal to the axis of the pipe without moving the pipe by a pipe drawing margin in the axial direction of the pipe. In addition, when the third pipe has been provided, if the third pipe is removed in advance, it is possible to remove the pipe from the blocks without moving the block at all.

### BRIEF DESCRIPTION OF THE DRAWINGS

FIG. 1 is a partial cutaway sectional plan view illustrating a state in which blocks facing each other have been coupled to each other via a pipe according to the present invention.

FIG. 2 is a partial sectional plan view illustrating one of connection portions between the pipe and the blocks.

FIGS. 3A and 3B illustrate a connection portion between the pipes, FIG. 3A is a partial cutaway sectional plan view illustrating a state in which a male thread member has been engaged with a cap nut member, and FIG. 3B a partial cutaway sectional plan view illustrating a state in which the engagement has been released.

FIGS. 4A and 4B illustrate the pipes according to a second example, FIG. 4A is a partial cutaway sectional plan view illustrating a state in which the male thread members have been attached to both ends of a third pipe, and FIG. 4B is a partial cutaway sectional plan view illustrating a state in which the male thread member and the cap nut member have been attached to both ends of the third pipe.

FIG. 5 is a partial cutaway sectional plan view illustrating the pipe according to a modification of the second example.

FIGS. 6A and 6B illustrate the pipe according to a third example, FIG. 6A is a sectional plan view illustrating a state in which the male thread members have been attached to both ends of the third pipe, and FIG. 6B is a partial cutaway sectional plan view illustrating a state in which one outward flange has been removed.

FIGS. 7A and 7B illustrates a conventional pipe, FIG. 7A is a partial cutaway sectional plan view illustrating co-rotation when the pipe is attached to the blocks, and FIG. 7B is a partial cutaway sectional plan view illustrating a connection portion between the pipe and the blocks.

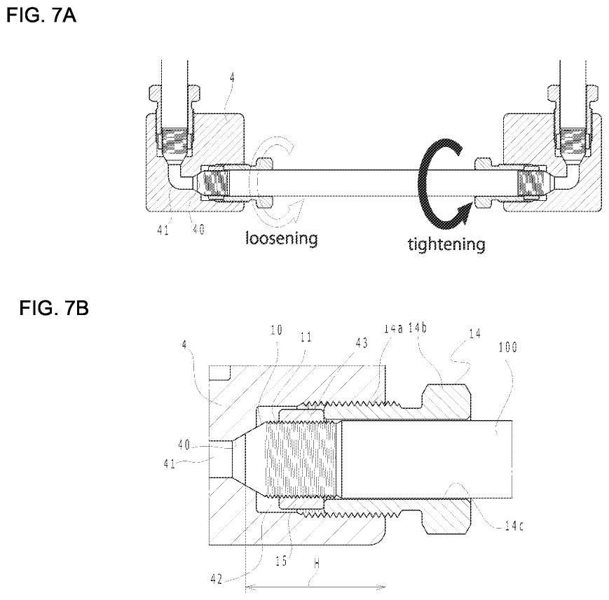

### DESCRIPTION OF THE PREFERRED EMBODIMENTS

Pipes according preferred embodiments of the present invention will be described with reference to the drawings. The shapes of components described in this example, the relative disposition thereof, and the like are only description examples and are not intended to limit the scope of the present invention unless otherwise specified. In addition, the directions of members and the like may be referred to as up, down, left, and right depending on the direction in the drawings for convenience, but this does not limit the scope of the present invention.

### First Embodiment

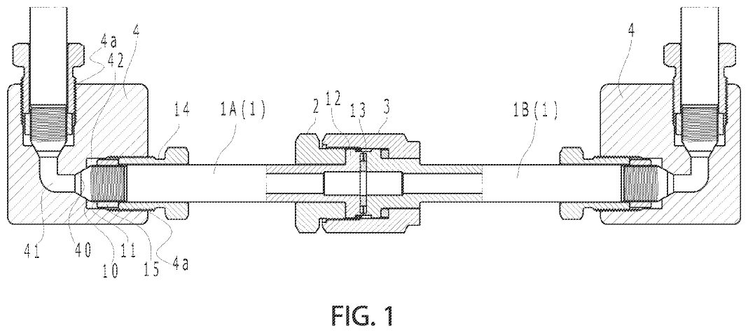

FIGS. 1 to 3 illustrate a first embodiment of the present invention. FIG. 1 is a partial cutaway front sectional view illustrating a state in which blocks 4 facing each other have been coupled to each other via pipes 1A and 1B according to the present invention.

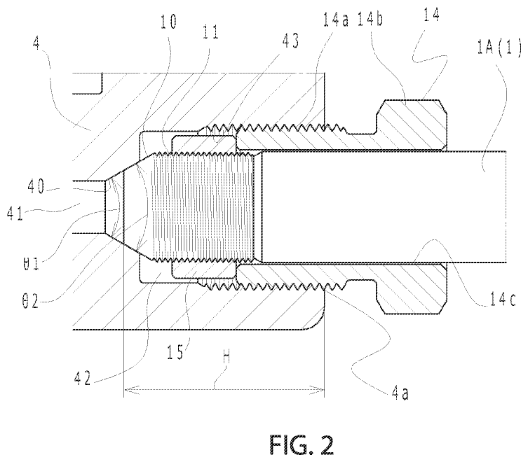

In the pipe according to the present invention, one end forms a male portion of a so-called cone thread joint that comes into contact with a tapered seal portion 40 of the block 4 to prevent leakage of internal fluid, and the other end has a joint structure to be fastened to an annular gasket 13 via a screw member. Specifically, as illustrated in FIG. 1, a pipe 1 including at least first and second pipes connects the blocks 4 and 4 each having an internal flow path 41 and an open end 4a of the flow path 41 on a surface thereof, and one end portion connected to the block 4 has a common structure and, as illustrated in FIG. 2, has a tapered surface 10 that abuts against the taper seal portion 40 and a male thread portion 11 formed closer to the other end portion than the tapered surface 10. A stopper 15 is screwed with the male thread portion 11 as in the conventional example, and the pipe 1 is inserted into a fixing member 14 that has a through-hole 14c with a diameter slightly larger than the diameter of the pipe 1 and has, on a peripheral surface thereof, an engagement portion 14b with a width across flats or a hexagonal shape through which a male thread portion 14a is engaged with a tool.

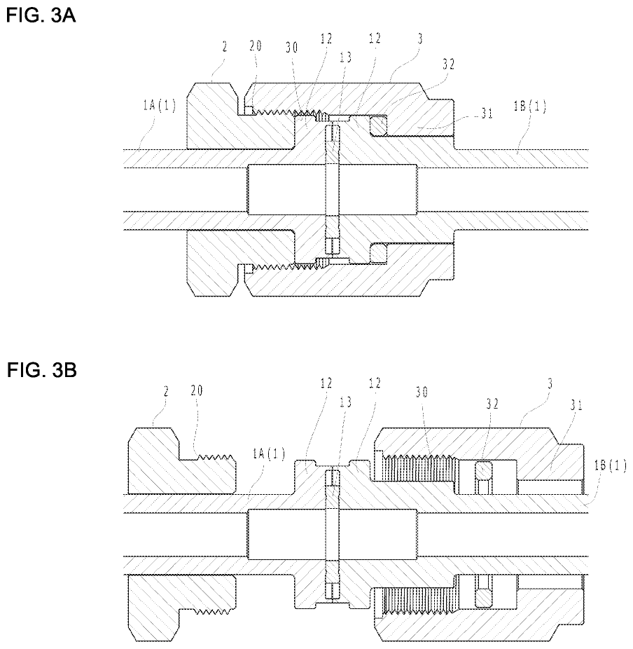

The other end portion of the pipe 1 has a joint structure as illustrated in FIGS. 3A and 3B. The other end portion of the pipe 1A is provided with an outward flange 12, the annular gasket 13 is interposed between butt end faces, male threads 20 are formed on a peripheral surface of a male thread member 2 to be inserted onto the pipe, and the male thread member 2 abuts against the outward flange 12. The other end portion of the pipe 1B is provided with the outward flange 12 having the same shape as in the other end portion of the pipe 1A, female threads 30 to be screwed with the male threads 20 to be inserted onto the pipe are formed on an inner peripheral surface, and a cap nut member 3 provided with an inward flange 31 to be engaged with the outward flange 12. A co-rotation prevention member 32 (for example, a thrust bearing) that prevents co-rotation is provided between the inward flange 31 and the outward flange 12 of the pipe 1B.

In the structure described above, when the blocks 4 and 4 are coupled to each other, the cone thread joint sides of the pipes 1A and 1B are attached to the blocks 4 and 4. First, as in the conventional example, the tapered surface 10 at the end of the pipe 1 is pushed against the tapered seal portion 40 of the block 4, the male thread portion 14a of the fixing member 14 are screwed with the female thread portion 43 formed on the inner peripheral surface in an installation space 42 closer to the open end than the tapered seal portion 40 of the block 4, the fixing member 14 is screwed until the end of the fixing member 14 abuts against the stopper 15, and accordingly, the tapered surface 10 abuts against the tapered seal portion 40 to achieve sealing. Regarding the angles of the tapered seal portion and the tapered surface, for example, when the expansion angle θ1 of the tapered seal portion is 60 degrees, the expansion angle θ2 of the tapered surface is 59 degrees, which is preferably slightly more acute than the expansion angle θ1.

After the pipes 1A and 1B are fixed to the blocks 4 and 4, the other ends of these pipes are brought into contact with each other, and the male thread member 2 is screwed with the cap nut member 3, and accordingly, the annular gasket 13 provided between butt end faces is pushed with a predetermined force to prevent the fluid passing through the pipe 1 from leaking to the outside.

When the pipe 1 needs to be removed from the blocks 4 due to maintenance or the like, the pipe 1 can be removed from the blocks 4 only by releasing the screwing between the male thread member 2 and the cap nut member 3 and moving one of the blocks 4 by the distance equivalent to the diameter of the pipe 1 in one of directions orthogonal to the axis of the pipe 1.

### Second Embodiment

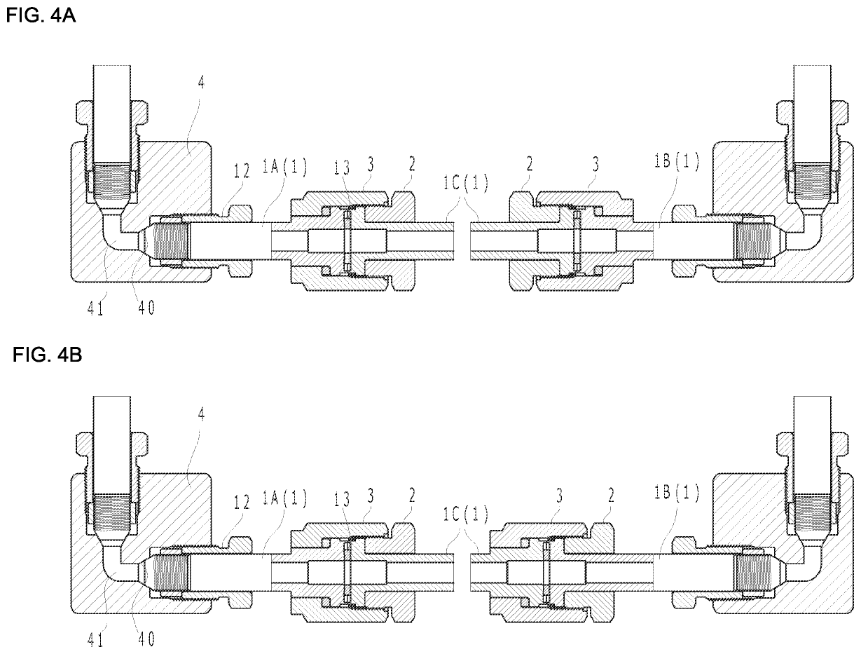

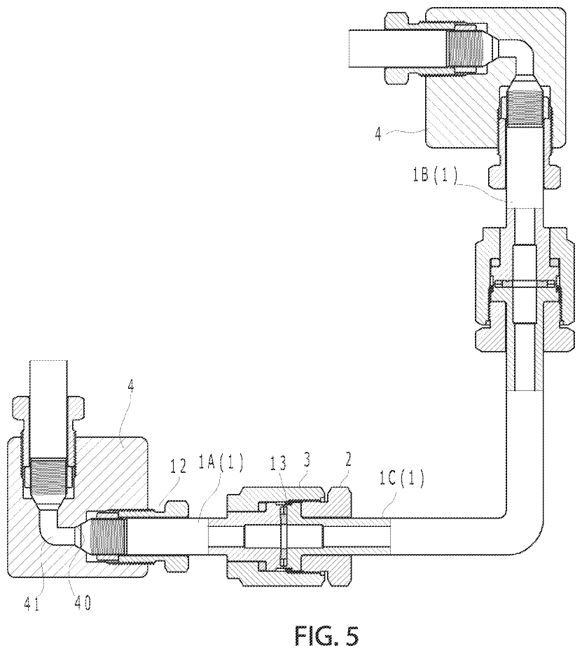

FIGS. 4A to 5 illustrate a second embodiment of the present invention. FIG. 4A is a partial cutaway front sectional view illustrating a state in which the blocks 4 facing each other are coupled to each other by using pipes 1A, 1B, and 1C according to the present invention.

In the present embodiment, the third pipe 1C is provided between the pipe 1A and the pipe 1B according to the first embodiment, and the connection between the pipes 1A and 1B and the blocks 4 is the same as that in the first embodiment, and accordingly, description thereof is omitted.

The third pipe 1C provided between the pipe 1A and the pipe 1B has the outward flanges 12 and either the male thread member 2 or the cap nut member 3 at both ends thereof. FIG. 4A illustrates an example in which the male thread members 2 are provided at both ends, and FIG. 4B illustrates an example in which the male thread member 2 is provided at one end and the cap nut member 3 is provided at the other end. The members are determined as appropriate depending on whether the joint members provided in the end portions of the pipes 1A and 1B are the male thread members 2 or the cap nut members 3. When the present embodiment is adopted, the joint members provided in the other end portions of the pipe 1A and the pipe 1B can be either the male thread members 2 or the cap nut members 3. In addition, since the lengths of the pipe can be adjusted by changing the length of the pipe C, cost reduction can be achieved by making the pipe 1A and the pipe 1B identical to each other.

Since the outward flanges 12 are formed at both ends of the pipe 1C, the pipe is divided approximately in the middle to attach the male thread member 2 and the cap nut member 3, and the pipe 1C is formed by using a joint method, such as welding. In addition, the male thread member 2 and the cap nut member 3 may have a two-part structure.

In the present embodiment in which the third pipe 1C is provided between the pipe 1A and the pipe 1B, since the blocks 4 need not be moved when the blocks 4 are coupled or when the pipe 1 is removed for maintenance, maintenance can be performed easily even in a facility in which the block 4 has been fixed after construction.

In addition, when the pipe 1C bent at an arbitrary angle is used as illustrated in FIG. 5, the blocks can be easily coupled to each other even at an irregular construction site in which, for example, the open ends of the blocks 4 do not face each other, and accordingly, maintenance can be performed smoothly.

### Modifications

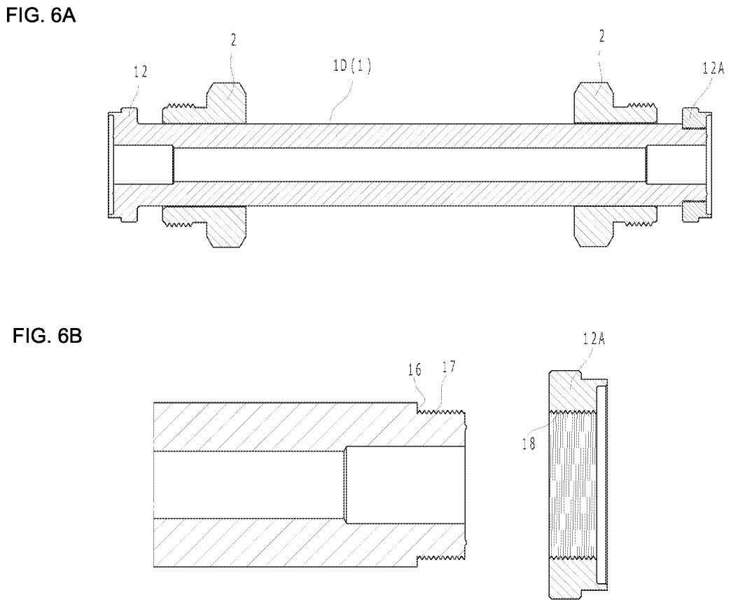

FIGS. 6A and 6B illustrate illustrates a modification of the second embodiment of the present invention. FIG. 6A is a front sectional view of the pipe 1C according to the present embodiment.

In the modification, at least one outward flange 12 of the third pipe 1C can be retrofitted to an end portion.

In the example illustrated in FIGS. 6A and 6B illustrate, a stepped portion 16 is provided at one end of the pipe 1C, and male threads 17 are engraved in a small-diameter portion. The outward flange according to the present embodiment includes an annular member 12A having, on the inner surface thereof, female threads 18 to be screwed with the male threads 17 of the small-diameter portion.

The annular member 12A may be attached to the pipe 1C by being screwed with a screw, fitted by tightening, or fixed by welding.

When the outward flange can be retrofitted as described above, since there is no need to connect the pipe by welding, fluid can be effectively prevented from leaking to the outside due to poor welding.

### INDUSTRIAL APPLICATION

The pipe according to the present invention can be preferably used to couple blocks having flow paths and can also be preferably used to replace an existing facility including cone thread joints.

### REFERENCE SIGNS LIST

1: pipe
10: tapered surface
11: male thread portion
12: outward flange
12A: annual member
2: male thread member
20: male threads
3: cap nut member
31: inward flange
4: block
40: tapered seal portion
41: flow path

What is claimed is:

1. A pipe that connects blocks each having an internal flow path and an open end of the flow path on a surface thereof, the pipe comprising:
at least a first pipe and a second pipe,
wherein one end portion of each of the first and second pipes is provided with a tapered surface that comes into contact with a tapered seal portion formed at an open end of each of the blocks and a male thread portion closer to another end portion of each of the first and second pipes than the tapered surface,
the other end portion is provided with an outward flange, and an annular gasket is interposed between butt end faces of the first and second pipes, and
the other end portion of the first pipe is provided with a male thread member that is inserted onto the first pipe, has male threads on a peripheral surface thereof, and abuts against the outward flange, and the other end portion of the second pipe is provided with a cap nut member that is inserted onto the second pipe, has female threads on an inner surface thereof to be screwed with the male threads, and has an inward flange to be engaged with the outward flange.

2. The pipe according to claim 1,
wherein a third pipe is provided between the first and second pipes connected to the blocks, and the third pipe has the outward flange and the male thread member or the cap nut member at both ends thereof.

3. The pipe according to claim 2,
wherein at least one of the outward flanges is retrofittable to an end portion of the third pipe.
